(19) United States
(12) Patent Application Publication
(10) Pub. No.: US 2011/0308123 A1
(43) Pub. Date: Dec. 22, 2011

(54) Multiple message sign assembly

(76) Inventor: J. Greg Williams, Louisville, KY (US)

(21) Appl. No.: 12/801,701

(22) Filed: Jun. 22, 2010

(51) Int. Cl. G09F 7/00

(52) U.S. Cl. 40/611.1

(57) ABSTRACT

A rectangular vertically oriented sign assembly is mountable on the wall adjacent a room in any suitable manner. It includes a front panel through which signs are visible. The front panel is preferably made of a non-glare acrylic material that is transparent. The sign assembly permits display of a plurality of different messages simultaneously. The front panel is divided up into a plurality of separate windows through which separate signs may be concurrently visible. The assembly includes two pockets between its front surface and rear surface that are open to one side to allow insertion of signs. The pockets are spaced from one another by an internal wall that corresponds to the horizontal opaque bar printed on the front panel.

### BACKGROUND OF THE INVENTION

The present invention relates to a multiple message sign assembly. In the prior art, sign assemblies are well known including those which facilitate display of multiple messages. However, Applicant is unaware of any such assembly including all of the features, aspects and attributes of the present invention.

Applicant is aware of the following prior art:

U.S. Pat. No. 4,679,341 to Goldman discloses a modular display apparatus for sign panels. In Goldman, signs are held in a frame including reverse C-shaped framing portions with a front panel having openings therethrough through which the signs may be viewed. The present invention differs from the teachings of Goldman in a number of respects including the fact that in the present invention a non-glare acrylic panel is provided through which signs may be visible and the panel includes darkened areas to delineate between different windows on the panel.

U.S. Pat. No. 4,979,324 to Rehtmeyer et al. discloses a frame for displaying outfits or ensembles which includes a plurality of pockets that receive images of the head, torso and legs of a person wearing different outfits. The present invention differs from the teachings of Rehtmeyer et al. in several respects including that in order for the Rehtmeyer et al. device to operate as intended, the front member thereof disclosed as made of transparent plastic must be continuously transparent. By contrast, in the present invention, a plurality of windows are provided in a non-glare acrylic front panel which is coated or otherwise obscured in different areas to delineate the separate windows.

U.S. Pat. No. 5,092,066 to Brewster discloses a removable sign including several different sign holders allowing a plurality of signs to be visible vertically stacked within the device. In Brewster, the front panel is continuously transparent as compared to the present invention which has areas where the transparency of the front panel is obscured.

U.S. Pat. No. 7,146,758 to Gaston discloses a sign indicating status of occupant of cubicle or office and method of use. In Gaston, a plurality of pockets are provided that permit the exhibiting of any one of a plurality of signs in each one. A front frame includes three vertically spaced openings through which the signs are visible. This construction fails to protect the signs from damage or from being marked. In fact, this design is specifically devised because one of the signs is, in fact, a blank surface that is intended to be written upon through its respective opening. Additionally, Gaston includes a rear storage chamber for unused signs that makes the device extremely thick. By contrast, in the present invention, the front panel consists of a non-glare acrylic panel having portions obscured so that a plurality of vertically spaced windows are provided. Also, the present invention is relatively thin.

### SUMMARY OF THE INVENTION

The present invention relates to a multiple message sign assembly. The present invention includes the following interrelated objects, aspects and features:

(1) In a first aspect, the present invention is most particularly intended to be used in the environment of use of the wall adjacent a doorway permitting entrance to a hospital room. Hospital rooms have a number of serious hazardous issues that require notification to those who are visiting such rooms. For example, visitors need to know what precautions must be taken before entering the room of a patient. Thus, if a patient has a disease that is communicable through the air such as, for example, measles or chicken pox, it is important for susceptible persons who wish to enter the room to wear appropriate protection such as a mask. A sign notifying prospective visitors of such issues would be extremely helpful in protecting them from catching a disease from the patient in the room.

(2) Other situations for which appropriate signage would be helpful include reminders to wash one's hands or even to check with the attending nurse before entering the room. Providing a sign assembly that is aesthetically pleasing and allows easily changing the message is an advantageous improvement over present day notification techniques.

(3) The present invention contemplates a rectangular vertically oriented sign that is mountable on the wall adjacent a room in any suitable manner such as by adhesive, through screws, bolts, or any other suitable fastening means. In an important aspect of the present invention, it includes a front panel through which signs are visible. The front panel is preferably made of a non-glare acrylic material that is transparent. The present invention meets Americans With Disabilities Act (ADA) requirements.

(4) In the preferred embodiment, the inventive sign assembly permits display of a plurality of different messages simultaneously. In order to delineate between separate messages, the front panel is divided up into a plurality of separate windows through which the separate signs may be visible. The front panel is divided up, in one embodiment, by screen printing opaque sections to create the different windows. Thus, by screen printing, it is possible to create an opaque border around the entire periphery of the panel and a bar extending horizontally across the panel to provide the separate windows while the front panel is flat throughout.

(5) In the preferred embodiment, the inventive sign assembly includes two pockets between its front surface and rear surface that are open to one side to allow insertion of signs. The pockets are spaced from one another by an internal wall that generally corresponds to the horizontal opaque bar printed on the front panel. Preferably, the windows have outer dimensions slightly smaller than the outer dimensions of the respective pockets they overlie to conceal the edges of signs received in the pockets.

(6) Each pocket is thick enough from front to rear to facilitate accommodation of a plurality of signs stacked on top of one another within the pocket. In the preferred embodiment, each sign includes a tab so situated on a side edge of the sign that when a plurality of signs are inserted within a pocket, the tabs are vertically spaced from one another, with each including printing, coating, or the like so that the user can easily determine which tab corresponds to which message.

(7) The pockets may be of equal dimensions or one may be larger than the other. In the preferred embodiment, the upper pocket is smaller top to bottom than the lower pocket. The upper pocket can thus receive a message that is smaller in nature, such as, certain initials that are meaningful to hospital staff while the lower pocket can receive messages that are larger in size and may include significant printed paragraphs, even in multiple languages.

(8) In the preferred embodiment, the signs received within the pockets are made of a material either plastic or coated with plastic so that the signs are easily cleaned and sterilized to avoid spreading of germs. Each sign may have printing on both faces and each tab is color coded on both sides corresponding to each respective message.

As such, it is a first object of the present invention to provide a multiple message sign assembly.

It is a further object of the present invention to provide such a device in which a sign assembly includes a plurality of pockets, each of which is sized to receive a plurality of stacked alternative messages.

It is a yet further object of the present invention to provide such a sign assembly in which the front panel is made of a non-glare acrylic with opaque areas defining windows permitting a plurality of signs to be made visible therethrough.

It is a still further object of the present invention to provide such a sign assembly in which the signs stacked within a pocket have laterally extending tabs that are vertically spaced from one another to allow the user to easily select which sign will be visible through the front panel of the sign assembly.

These and other objects, aspects and features of the present invention will be better understood by those of ordinary skill in the art when reviewing the following Specific Description of the Preferred Embodiments when taken in conjunction with the appended drawing figures.

### BRIEF DESCRIPTION OF THE DRAWINGS

FIG. 1 shows a front view of the present invention.

FIG. 2 shows a cross-sectional view along the line 2-2 of FIG. 1.

FIG. 3 shows an end view of the present invention.

FIG. 4 shows a cross-sectional view along the line 4-4 of FIG. 1.

FIG. 5 shows a cross-sectional view along the line 5-5 of FIG. 1.

FIG. 6 shows a front view of the present invention with a plurality of signs installed therein showing the side extending tabs.

FIG. 7 shows a plurality of different signs alternatively visible in the lower pocket of the inventive device.

FIG. 8 shows a plurality of signs alternatively visible in the upper pocket of the inventive device.

FIG. 9 shows an exploded view of a template placeable on a front panel of the inventive device to facilitate screen printing or other printing of opaque sections on the front panel to define the windows thereof.

FIGS. 10-13 show examples of signs used in accordance with the teachings of the present invention.

### SPECIFIC DESCRIPTION OF THE PREFERRED EMBODIMENT

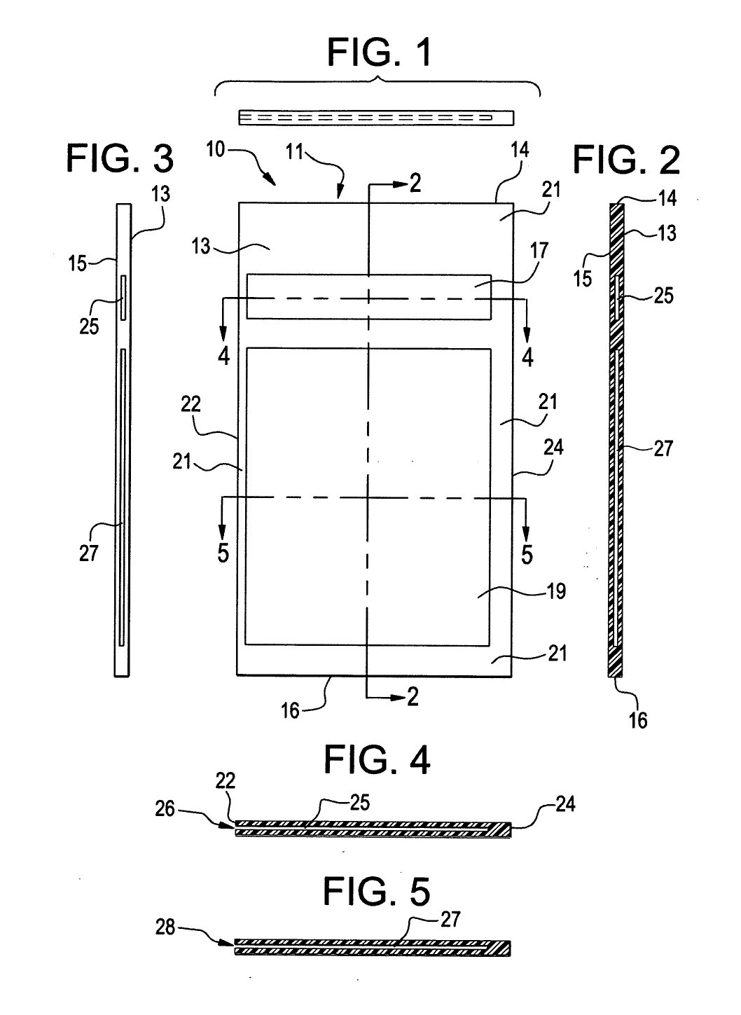

Reference is first made to FIGS. 1-5. With reference to FIG. 1, the present invention is generally designated by the reference numeral 10 and includes a generally rectangular body 11 having a front face 13 and a rear face 15 (FIGS. 2 and 3). The front face 13 is flat and includes transparent regions or windows 17 and 19. With particular reference to FIG. 1, the windows 17 and 19 are delineated by an opaque area 21. The opaque area 21 separates the windows 17 and 19 and also completely surrounds each of the windows 17 and 19.

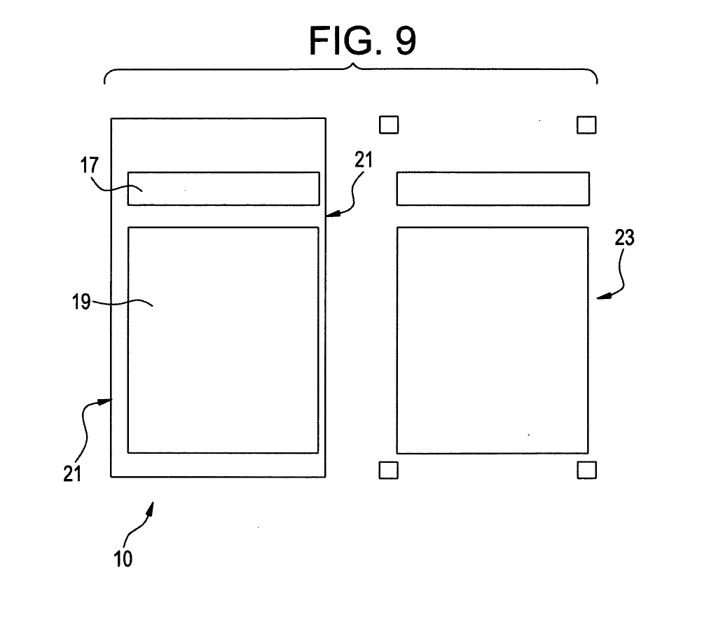

In the preferred embodiment of the present invention, the body 11 of the inventive sign assembly 10 including front face 13 is made of an acrylic material such as, for example, that which is known by the trademark PLEXIGLAS®. The surface 13 is provided with a non-glare finish by any suitable well known means. One preferred way of creating the opaque areas 21 is through the use of screen printing. In this regard, reference is made to FIG. 9 which shows the inventive device 10 and a template 23 that is adhered over the surface 13 of the assembly 10 to cover the areas where the windows 17 and 19 are located. With the template 23 in place, a screen printing technique is utilized to coat the areas comprising the opaque areas 21 as best seen in FIG. 1.

Behind each window 17, 19 is a pocket within the body 11 that is sized to receive a plurality of signs. Thus, with reference to FIGS. 2-5, it is seen that a pocket 25 is located directly behind the window 17 and a pocket 27 is located directly behind the window 19. With reference to FIG. 4, the pocket 25 has a side opening 26, and with reference to FIG. 5, the pocket 27 has a side opening 28. Again, each of the pockets 25 and 27 is sufficiently thick enough to receive a plurality of signs therein stacked one on top of the other. Preferably, each window is sized with outer dimensions slightly smaller than the outer dimensions of the respective pocket it overlies to hide the edges of signs received in the pocket.

With further reference to FIGS. 1 and 2, the body 11 also includes a top surface 14 and a bottom surface 16 along with side surfaces 22 and 24 (FIGS. 1 and 4).

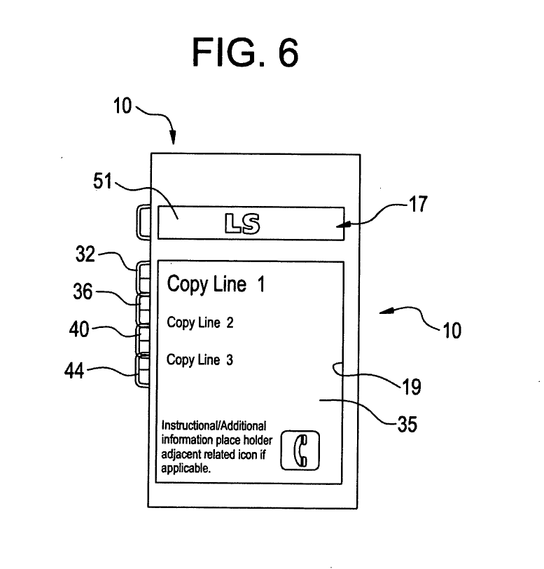

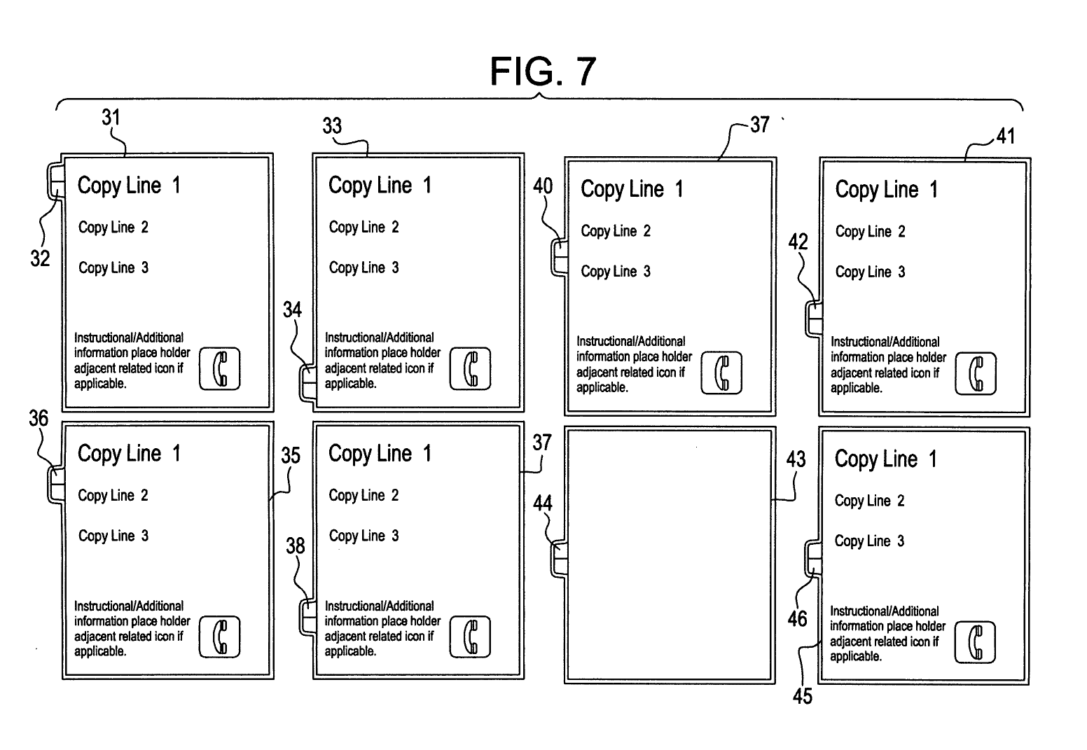

With reference to FIG. 7, a plurality of signs 31, 33, 35, 37, 39, 41, 43 and 45 are shown. Each of these signs has a tab. The sign 31 has a tab 32, the sign 33 has a tab 34, the sign 35 has a tab 36, the sign 37 has a tab 38, the sign 39 has a tab 40, the sign 41 has a tab 42, the sign 43 has a tab 44, and the sign 45 has a tab 46. In viewing FIG. 7, it is clear that each of the tabs is at a unique vertical position along the left side edge of its respective sign. Thus, when a plurality of signs are stacked one on top of one another, each of the tabs is separately visible. This is shown with reference to FIG. 6.

Additionally, each of the tabs is coded with either a pattern of colors or some other indicia so that the user can tell from looking at the tab what message is displayed on the sign. In this way, it is easy for the user to identify which sign is to be used and to place that sign on the top of the pile so that it is visible through the window 19.

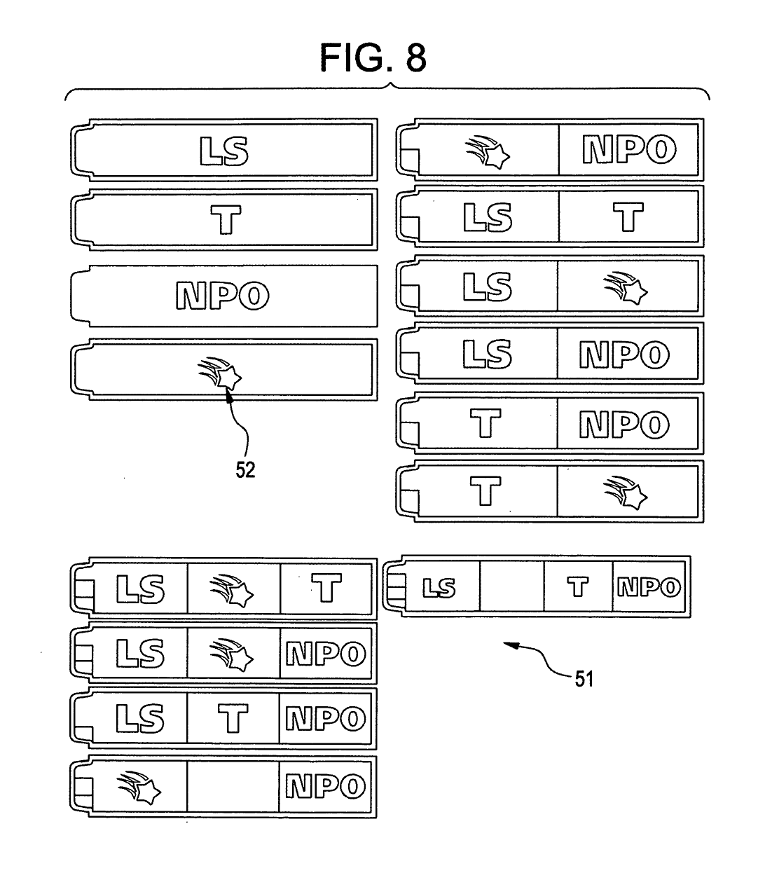

With reference to FIG. 8, a plurality of vertically shorter signs collectively identified by the reference numeral 51 are shown. Each of these signs has a leftward facing tab so that they may be gripped to be removed from the pocket 25 so that the desired sign may be placed at the top of the pile visible through the window 17. One sign including the lettering “LS” is seen in FIG. 6. The lettering on the signs 51 has specific meanings: LS=Latex Sensitive; T=Patient to be turned; NPO=“Nil per os”: withhold oral food and fluids; the star symbol 52=Fall Hazard.

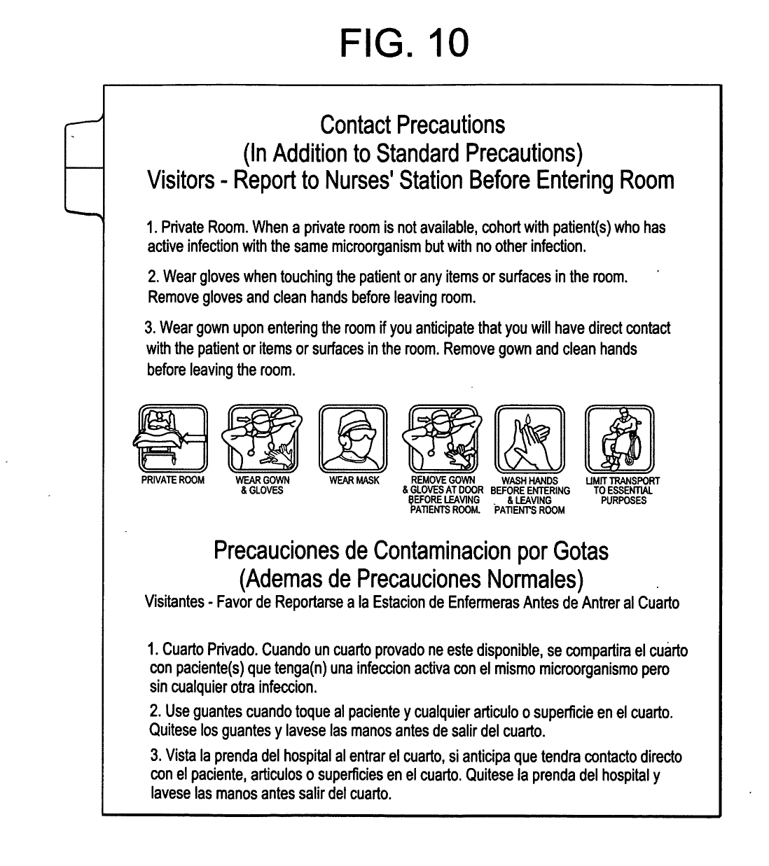

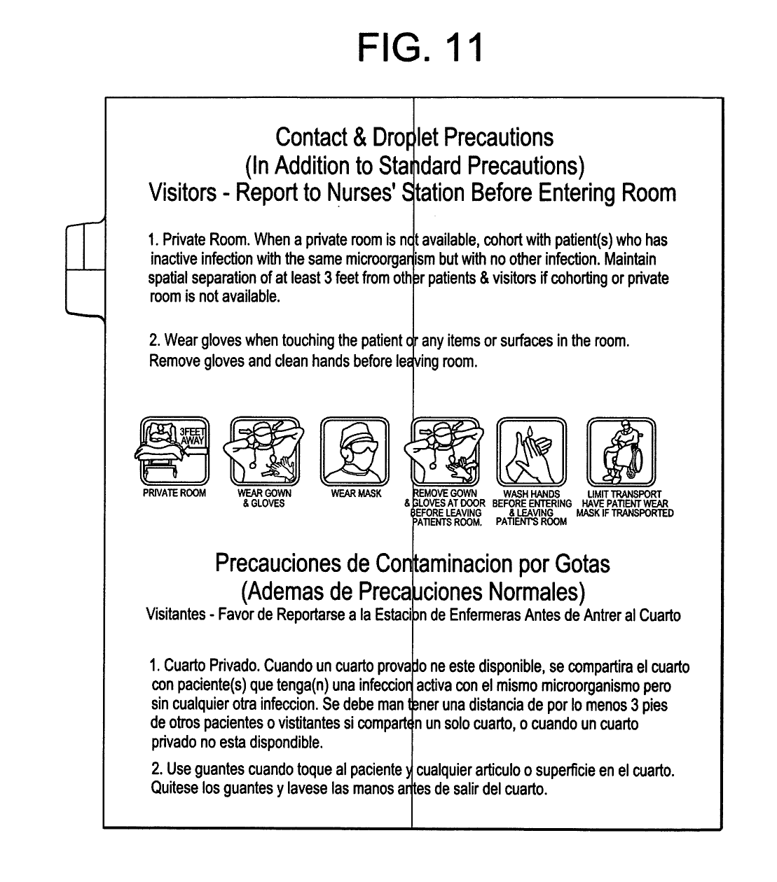

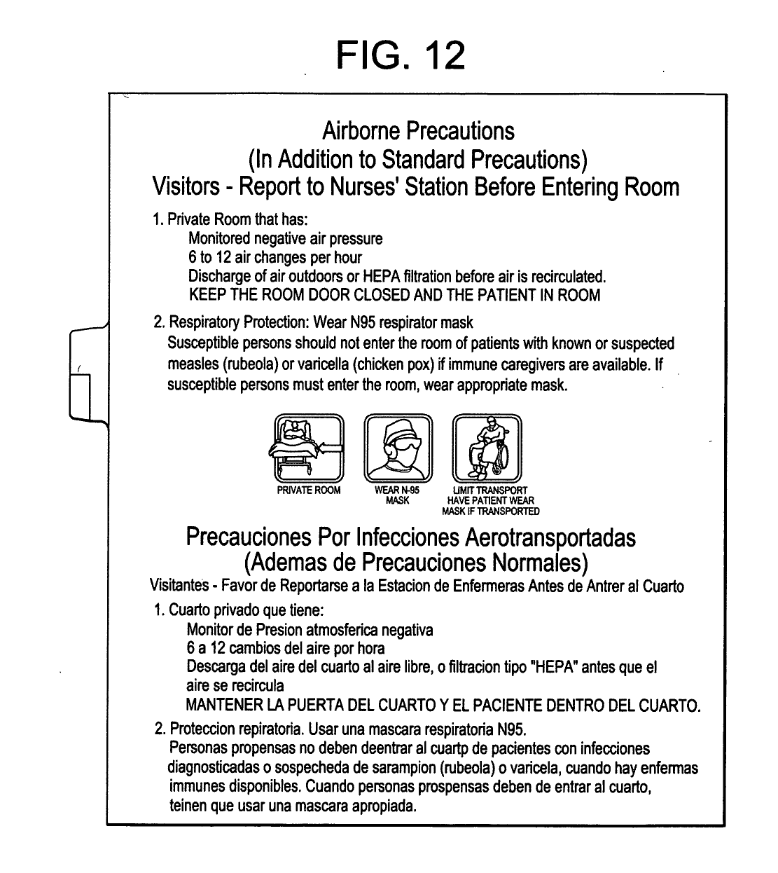

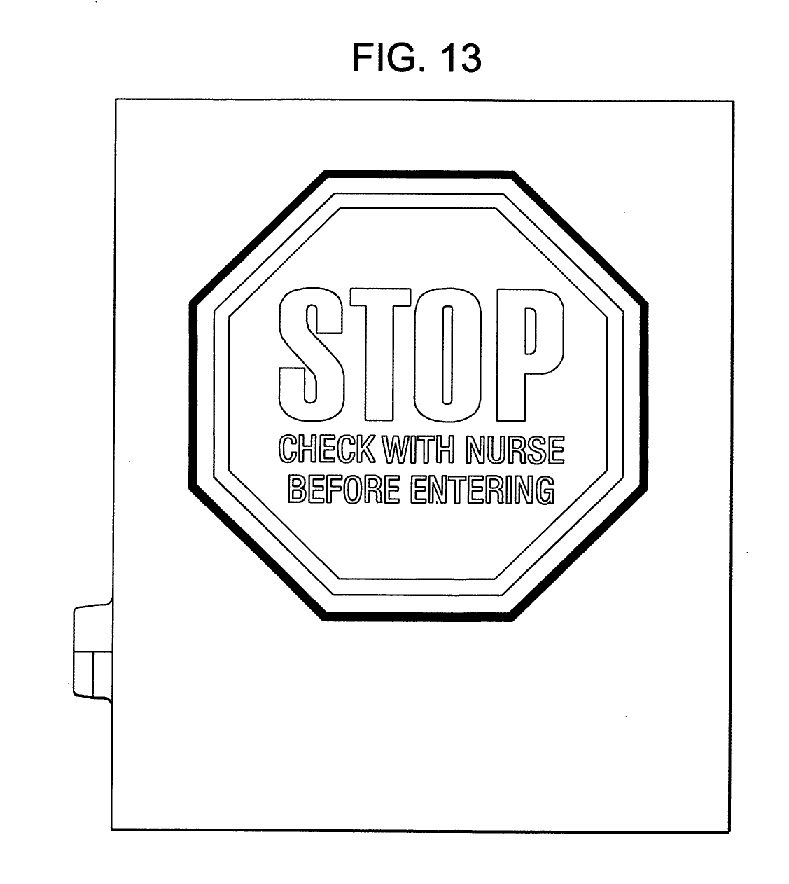

FIGS. 10-13 show examples of some of the messages that may be displayed on the signs visible through the window 19.

The inventive device 10 may be fabricated in any one of a number of preferred ways. One way would be to mold it in a single piece out of an acrylic material in a molding operation. Another way would be to assemble it by providing two pieces of acrylic material of the dimensions corresponding to the outer walls of the device as seen in FIG. 1, and then interconnect them together via additional pieces of acrylic material that create the dividers between the pockets and extend about the periphery. In such an assembly, suitable adhesive is used to assemble the component parts together permanently.

The inventive assembly 10 may be installed on a wall by any suitable means such as a bracket, screws, hook and pile fastening means such as is sold under the trademark VELCRO® or even through the use of an appropriate strong adhesive. In the preferred embodiment, the signs are made of either a plastic material or another material coated or laminated with plastic so that the surfaces of the signs may easily be cleaned and sterilized for appropriate use in the hospital setting.

As such, an invention has been disclosed in terms of a preferred embodiment thereof which fulfills each and every one of the objects of the invention as set forth hereinabove, and provides a multiple message sign assembly of great novelty and utility.

Of course, various changes, modifications and alterations in the teachings of the present invention may be contemplated by those of ordinary skill in the art without departing from the intended spirit and scope thereof.

As such, it is intended that the present invention only be limited by the terms of the appended claims.

1. A sign assembly, comprising:
a) a generally flat body having a flat front surface with at least two transparent regions thereon, said transparent regions being defined by opaque regions surrounding them;
b) a pocket behind each transparent region, each pocket having an access opening in a side wall of said body;
c) a first set of signs removably received in a first of said pockets and a second set of signs removably received in a second of said pockets, a front sign from each of said first and second sets being visible through a respective one of said transparent regions;
d) at least said first set of signs comprising a plurality of stacked signs, each sign having a tab on a side thereof next to said access opening of said pocket receiving said signs, when said signs are received therein, respective ones of said tabs being vertically staggered with respect to one another so that with said signs received in said pocket, all of said tabs are readily visible; and
e) each sign of said second set of signs having a tab on a side thereof next to said access opening of said pocket receiving said second set of signs when said signs are received therein.

2. The assembly of claim 1, wherein said body is made of an acrylic material.

3. The assembly of claim 2, wherein said front surface has a non-glare finish.

4. The assembly of claim 1, wherein said transparent regions on said front surface are rectangular.

5. The assembly of claim 4, wherein said opaque regions include a periphery of said front surface, whereby said transparent regions are spaced from said periphery, said opaque regions being formed using a screen printing process.

6. The assembly of claim 1, wherein said transparent regions comprise first and second windows.

7. The assembly of claim 6, wherein said first window is larger than said second window.

8. The assembly of claim 7, wherein said first window is below said second window, each said window having outer dimensions smaller than outer dimensions of a respective pocket said window overlies, whereby edges of a sign received in said pocket are not visible through said window.

9. The assembly of claim 1, wherein said tabs of said first set of signs are provided with color coding.

10. The assembly of claim 9, wherein said color coding comprises at least one color.

11. The assembly of claim 10, wherein said color coding comprises a plurality of colors.

12. The assembly of claim 1, wherein said signs are made of plastic.

13. The assembly of claim 12, wherein said body is made of an acrylic material.

14. The assembly of claim 1, wherein said body is generally rectangular.

15. The assembly of claim 14, wherein said body is vertically elongated.

16. A sign assembly, comprising:
a) a generally flat rectangular vertically elongated acrylic body having a flat front surface with at least two rectangular transparent regions thereon, said transparent regions comprising first and second windows and being defined by opaque regions surrounding them;
b) a pocket behind each transparent region, each pocket having an access opening in a side wall of said body;
c) a first set of plastic signs removably received in a first of said pockets and a second set of plastic signs removably received in a second of said pockets, a front sign from each of said first and second sets being visible through a respective one of said windows;
d) at least said first set of signs comprising a plurality of stacked signs, each sign having a tab on a side thereof next to said access opening of said pocket receiving said signs when said signs are received therein, respective ones of said tabs being vertically staggered with respect to one another so that with said signs received in said pocket, all of said tabs are readily visible; and
e) each sign of said second set of signs having a tab on a side thereof next to said access opening of said pocket receiving said second set of signs when said signs are received therein.

17. The assembly of claim 16, wherein said front surface has a non-glare finish.

18. The assembly of claim 16, wherein said opaque regions include a periphery of said front surface, whereby said transparent regions are spaced from said periphery, said opaque regions being formed using a screen printing process.

19. The assembly of claim 16, wherein said first window is larger than said second window, and said first window is below said second window.

20. The assembly of claim 16, wherein said tabs of said first set of signs are provided with color coding, said color coding comprising at least one color.
